(19) United States
(12) Patent Application Publication
(10) Pub. No.: US 2003/0200869 A1
(43) Pub. Date: Oct. 30, 2003

(54) Simplified ionizer plate for an ionizing wet scrubber

(76) Inventor: William A. Brock, Wildwood, MO (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 10/132,395

(22) Filed: Apr. 26, 2002

(51) Int. Cl. B03C 3/00

(52) U.S. Cl. 96/52

(57) ABSTRACT

An ionizer plate design for an ionizing wet scrubber which reduces the size of a scrubber for a given mass flow, reduces the number of parts and complexity of the ionizing plates from previous designs, and utilizes components which have a low electrical conductivity.

### BACKGROUND OF THE INVENTION

An apparatus for cleaning a gas stream patented by Klugman et al, under U.S. Pat. No. 3,958,958 has been in use for many years and has been very effective in selected applications. In the ionizing section of this machine the air passes between a plurality of corona wires and tubes. In more recent designs the tubes are actually fabricated metal plates with two parallel surfaces joined by a series of channels. In the upper portion of each plate a liquid is brought into a liquid chamber which serves as a settling chamber to stabilize the flow. The liquid then flows over a small weir with a notched edge and down the two vertical parallel sides of the fabrication. Both sides of the fabrication are also parallel to the gas stream flow. The particles in the gas stream are charged in the corona around the wires, attracted to the opposite charge of the plate and flushed off of the plate into the sump by the flowing liquid.

### SUMMARY OF THE INVENTION

The present invention is a simplified ionizer plate design for this type of machine. This design uses a single flat plate of material instead a fabricated assembly of sheet and channels to provide a surface to attract the charged particles in the gas stream. The liquid chamber mounted on top of the plate in this design which may be made of a low electrical conductivity material flares out in upper portion of the chamber similar to the previous design. The lower portion of the liquid chamber, unlike the previous design, flares or tapers in to connect the surface of the liquid chamber with the surface of the plate and provide a continuous path on which the liquid flows. In some applications where the liquid has conductivity, a shield is employed which shields the liquid and the liquid chamber and acts as an insulator to prevent electrical discharge to the liquid or the liquid chamber.

By using a material with a low electrical conductivity for the liquid chamber and/or the shield in conjunction with a relatively thin flat plate, the ionizer plates in this type of machine can be moved closer together with minimal or very low electrical losses into the liquid or liquid chamber while maintaining approximately the same distance between the corona wires and the conducting surface of the plate as with the previous design. This savings, in consideration of the plurality of plates in a machine, substantially reduces the width of a machine for a given mass flow of gas stream and thereby significantly reduces the cost of a machine. The simplified plate design also reduces the manufacturing cost of the plates themselves and may provide some performance improvement.

The present invention is an improved ionizing plate design for an ionizing wet scrubber whereby the liquid flows into a liquid chamber mounted on top of a single plate, through the notched edges of the weir, and down the side of the liquid chamber which in the lower portion flares in towards the centerline of the assembly to meet the metal plate. An insulator shield may be used to shield the liquid and the liquid chamber in situations when the liquid has electrical conductivity. The liquid chamber and/or the shield may be made of a low electrical conductivity material such as plastic or ceramic. The metal plate supporting the liquid chamber and the shield is externally supported by one or more possible methods.

### BRIEF DESCRIPTION OF THE DRAWINGS

FIG. 1 shows front and cross sectional views of the plate design for this patent;

FIG. 2 shows front and cross sectional views of plate design currently in use with an ionizing wet scrubber; and

FIG. 3 compares the configuration of both plate designs to the corona wires and shows how the design in this patent reduces the width of the ionizing section of the scrubber.

### DETAILED DESCRIPTION OF THE INVENTION

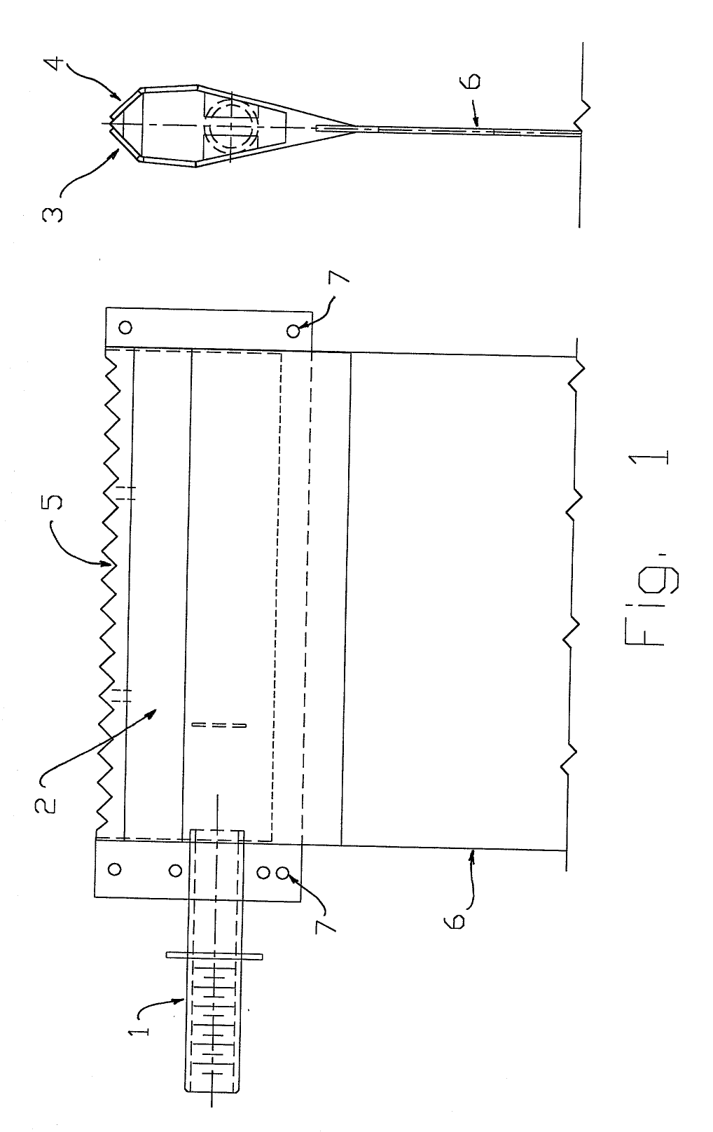

Referring to FIG. 1, the liquid flows into the liquid chamber through a tube 1 and into the liquid chamber 2. The liquid fills the chamber and flows over the notched weir plate 5 at the top of the liquid chamber and down both sides 3 and 4 of the liquid chamber to the metal plate 6. The shield 8 acts as an insulator to prevent electrical discharge to the liquid or the liquid chamber. In this figure the liquid chamber is shown as a two piece fabrication with flanges at both ends and pins and/or bolts through holes 7 aligning and/or joining the two pieces. The liquid chamber could, however, be made in one or more pieces and joined or bonded by one or more different methods or processes.

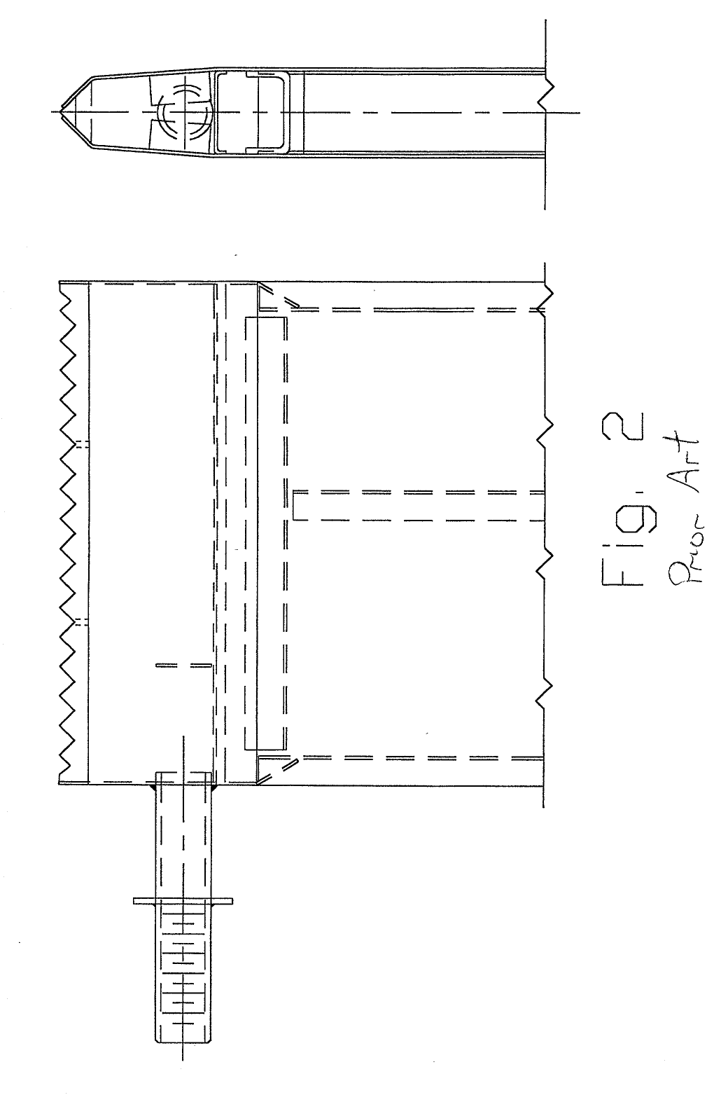

FIG. 2 is a plate of the design previous to this patent. The liquid flows into the liquid chamber through the tube 9, fills the liquid chamber 10, flows over the notched weir 11 at the top of the liquid chamber, and straight down both vertical sides of the fabrication 12 and 13.

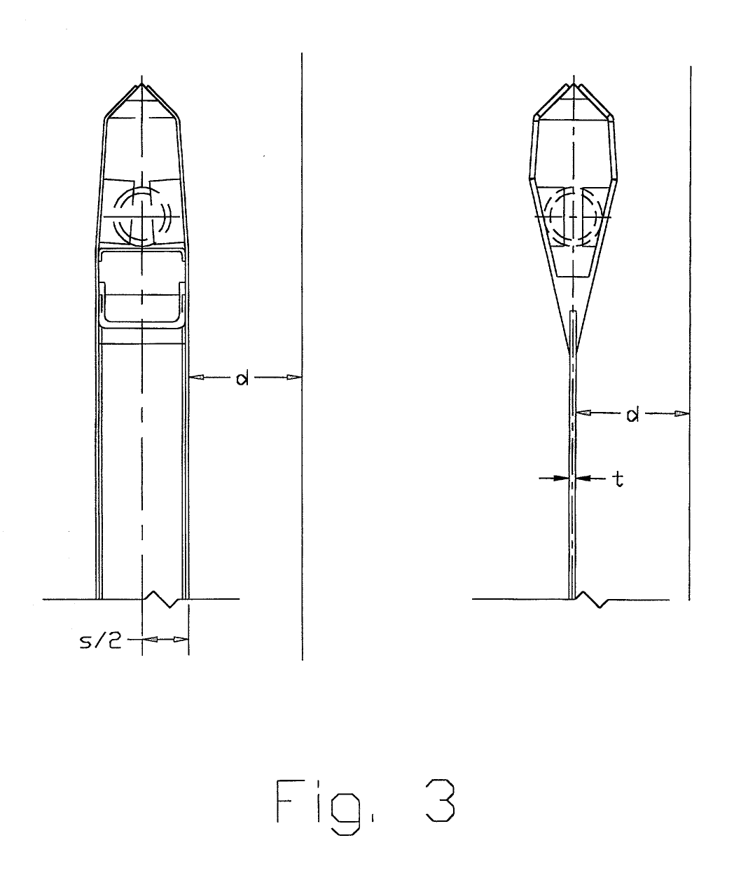

Referring to FIG. 3, for optimal performance, the distance from the corona wire to the surface of the plate is identified as “d” for the fabricated plate currently in service. Maintaining this distance for the design identified in this patent and recognizing that there is a plate on both sides of each corona wire, the total width savings for the new design is 2(s/2-t/2) multiplied times the number of corona wires in a particular machine.

In applications where the liquid has conductivity, an insulator shield may be used to shield the liquid and the liquid chamber. The liquid chamber may be made of a low electrical conductivity material such as plastic or ceramic. This acts as an insulator to prevent electrical discharge to the liquid or the liquid chamber. In conjunction with a relatively thin flat plate, the ionizer plates in this type of machine can be moved closer together with minimal or very low electrical losses into the liquid or liquid chamber while maintaining approximately the same distance between the corona wires and the conducting surface of the plate as with the previous design.

While the invention has been described with reference to a preferred embodiment, variations and modifications would be apparent to one of ordinary skill in the art without departing from the spirit of the invention. For instance, the liquid chamber could be cylindrical. Also, the opening in the top of the liquid chamber could be replaced with slots or perforations in the side of the chamber.

What is claimed is:

1. A ionizer plate, comprising:
a plate, said plate having a top edge and a bottom edge,
a liquid chamber attached to the top edges of the plate, the liquid chamber having a top half and a bottom half, and
at least one opening in the liquid chamber to allow liquid to flow through the at least one opening and down the plate.

2. The ionizing plate of claim 1, wherein the at least one opening is in the top half of the liquid chamber.

3. The ionizing plate of claim 1, further comprising a notched weir along the edge of the at least one opening.

4. The ionizing plate of claim 1, further comprising a tube for supplying liquid to the liquid chamber.

5. An apparatus for cleaning gas streams, comprising:
a plurality of plates, each plate having a top edge and a bottom edge,
each plate having a liquid chamber attached to the top edge of the plate, the liquid chamber having a top half and a bottom half,
at least one opening in the liquid chamber to allow liquid to flow through the at least one opening and down the plate, and
corona wires between the plates.

6. The gas stream cleaning apparatus of claim 5, wherein the at least one opening is in the top half of the liquid chamber.

7. The gas stream cleaning apparatus of claim 5, further comprising a notched weir along the edge of the at least one opening.

8. The gas stream cleaning apparatus of claim 5, further comprising a tube for supplying liquid to the liquid chamber.
